(19) United States
(12) Patent Application Publication
(10) Pub. No.: US 2026/0365076 A1
(43) Pub. Date: Nov. 19, 2026

(54) POWER SUPPLY SYSTEM AND METHOD OF FUEL CELL VEHICLE

(71) Applicants: Hyundai Motor Company, Seoul (KR); Kia Corporation, Seoul (KR)

(72) Inventors: Jae Ok HA, Hwaseong-si (KR); Joo Yeon Kim, Hwaseong-si (KR)

(73) Assignees: Hyundai Motor Company, Seoul (KR); Kia Corporation, Seoul (KR)

(21) Appl. No.: 19/399,121

(22) Filed: Nov. 24, 2025

(30) Foreign Application Priority Data
May 14, 2025 (KR) 10-2025-0062810

(51) Int. Cl. B60L 58/13; B60L 55/00; B60L 58/31; H02J 7/00; H02J 7/90; H02J 105/37

(52) U.S. Cl. CPC B60L 58/13; B60L 55/00; B60L 58/31; H02J 7/855; H02J 7/933; H02J 2105/37

(57) ABSTRACT

A power supply system of a fuel cell vehicle includes a battery disposed in the vehicle, a fuel cell stack generating electrical energy allowed to be supplied to the battery, and a processor determining whether to drive the fuel cell stack based on a state of charge (SoC) value of the battery and a required output of the fuel cell stack based on an external electric load being connected to the battery.

### CROSS-REFERENCE TO RELATED APPLICATION

The present application claims, under 35 U.S.C. § 119(a), the benefit of and priority to Korean Patent Application No. 10-2025-0062810 filed on May 14, 2025, the entire contents of which are incorporated herein by reference.

### BACKGROUND

### Field of the Present Disclosure

The present disclosure relates to a power supply system and method of a fuel cell vehicle. More particularly, it relates to a power supply system and method of a fuel cell vehicle allowing electrical energy of a battery disposed in the vehicle to be used outside the vehicle.

### Description of Related Art

Recently, in the case of an eco-friendly vehicle that uses an electric motor as a power source, such as a hybrid vehicle or an electric vehicle, a Vehicle to Load (V2L) function is provided to allow power of a battery installed in the vehicle to be used outside the vehicle for convenience of a user.

The V2L function refers to a function of converting electrical energy stored in the battery in the vehicle into alternating current that is utilizable by household electronic devices and supplying the alternating current to the outside of the vehicle. As outdoor activities such as camping become more popular, consumer preference for the V2L function is increasing.

Meanwhile, in the case of a fuel cell vehicle, a fuel cell stack capable of charging the battery in the vehicle is installed. A power supply system of the fuel cell vehicle may provide the V2L function only for a relatively short time depending on the state of charge (SoC) of the battery when entering a power-on mode. When the SoC of the battery reaches a lower limit requiring charging, the power supply system of the fuel cell vehicle needs to be switched to a utility mode in which the fuel cell stack is driven. When the fuel cell stack is driven, the battery may be charged with electrical energy output from the fuel cell stack.

A power supply system of a conventional fuel cell vehicle switches from the power-on mode to the utility mode through a user input module installed inside the vehicle. Therefore, a user using the V2L function outside the vehicle needs to enter the vehicle and switch a driving mode of the power supply system from the power-on mode to the utility mode before the SoC of the battery reaches the lower limit. When the user does not switch the driving mode of the power supply system, power from the battery will no longer be supplied to the outside of the vehicle.

In this way, the power supply system of the conventional fuel cell vehicle increases user inconvenience since the user needs to directly switch the driving mode.

The above information disclosed in this Background section is only for enhancement of understanding of the background of the present disclosure and therefore it may contain information that does not form the related art that is already known in this country to a person of ordinary skill in the art.

### BRIEF SUMMARY

The present disclosure has been made in an effort to solve the above-described problems associated with related art.

An aspect of the disclosed exemplary embodiments is to provide a power supply system and method of a fuel cell vehicle configured for automatically executing a utility mode for driving a fuel cell stack while electrical energy of a battery disposed in the vehicle is used outside the vehicle.

An aspect of the disclosed exemplary embodiments is not limited to the aspect mentioned above, and other aspects of the present disclosure not mentioned above will be clearly understood by those skilled in the art to which the present disclosure pertains from the description below.

According to various aspects of the present disclosure, the present disclosure provides a power supply system of a fuel cell vehicle including a battery disposed in the vehicle, a fuel cell stack generating electrical energy allowed to be supplied to the battery, and a processor determining whether to drive the fuel cell stack based on a state of charge (SoC) value of the battery and a required output of the fuel cell stack based on an external electric load being connected to the battery.

According to various aspects of the present disclosure, the processor may drive the fuel cell stack based on the SoC value of the battery being less than or equal to a predetermined lower limit, and the required output of the fuel cell stack being greater than or equal to a predetermined lower limit output.

According to various aspects of the present disclosure, the processor may s not drive the fuel cell stack based on the SoC value of the battery exceeding the predetermined lower limit.

According to various aspects of the present disclosure, the processor may not drive the fuel cell stack based on the required output of the fuel cell stack being less than the predetermined lower limit output.

According to various aspects of the present disclosure, the processor may redetermine the required output of the fuel cell stack based on the required output of the fuel cell stack being less than the predetermined lower limit output.

According to various aspects of the present disclosure, the required output of the fuel cell stack may be determined based on power consumption of the external electric load and a weight for the power consumption, and the weight may be determined based on a usage time of the external electric load.

According to various aspects of the present disclosure, the processor may be configured to determine and control output of the fuel cell stack based on the SoC value of the battery based on the fuel cell stack being driven.

According to various aspects of the present disclosure, the processor may stop driving of the fuel cell stack based on determining of the fuel cell stack being driven and the SoC value of the battery being greater than or equal to a predetermined first SoC value.

According to various aspects of the present disclosure, the processor may redrive the fuel cell stack based on driving of the fuel cell stack being stopped, a connection state of the external electric load and the battery being maintained, and the SoC value of the battery being less than or equal to a predetermined second SoC value.

According to various aspects of the present disclosure, the power supply system may enter a utility mode in which the fuel cell stack is driven based on the SoC value of the battery being less than or equal to a predetermined lower limit, and a required output of the fuel cell stack being greater than or equal to a predetermined lower limit output.

According to various aspects of the present disclosure, the present disclosure provides a power supply method of a fuel cell vehicle including determining, by a processor, whether to interconnect a battery disposed in the vehicle and an external electric load of the vehicle determining, by the processor, required output of a fuel cell stack disposed in the vehicle and configured to generate electrical energy allowed to be supplied to the battery, and driving, by the processor, the fuel cell stack based on the external electric load being connected to the battery, the SoC value of the battery being less than or equal to a predetermined lower limit, and the required output of the fuel cell stack being greater than or equal to a predetermined lower limit output.

Other aspects and exemplary embodiments of the present disclosure are discussed infra.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the present disclosure are discussed infra.

### BRIEF DESCRIPTION OF THE DRAWINGS

The above and other features of the present disclosure will now be described in detail with reference to certain exemplary embodiments thereof illustrated in the accompanying drawings which are provided hereinbelow by way of illustration only, and thus are not limitative of the present disclosure.

FIG. 1 is a schematic diagram illustrating a power supply system of a fuel cell vehicle according to an exemplary embodiment of the present disclosure;

FIG. 2 is an exemplary diagram illustrating an external power consumption weight according to a usage time of an external electric load according to an exemplary embodiment of the present disclosure; and

FIG. 3 and FIG. 4 are flowcharts illustrating a control process for continuous power supply of the power supply system according to an exemplary embodiment of the present disclosure.

It should be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Hereinafter, various exemplary embodiments of the present disclosure will be described with reference to the appended drawings. Matters included in the appended drawings are schematically illustrated for ease of description of embodiments of the present disclosure and may differ from an actually implemented form. In addition, in description with reference to the appended drawings, identical or corresponding components may be assigned the same drawing numbers, and redundant descriptions thereof may be omitted.

In addition, the terms “. . . section”, “. . . unit”, “. . . module”, etc., described in the specification mean a unit that processes at least one function or operation, which may be implemented by hardware, software, or a combination of hardware and software.

In addition, the terms used in the specification are only used to describe various exemplary embodiments and are not intended to limit the embodiments. A singular expression includes a plural expression unless the context clearly dictates otherwise.

In addition, even though the terms “first” and “second” in the present specification may be used to describe various components, the components are not limited by the terms. The terms are only used to distinguish one component from other components. Accordingly, without departing from the scope of rights according to the concept of the present disclosure, a first component may be referred to as a second component, and the second component may be referred to as the first component.

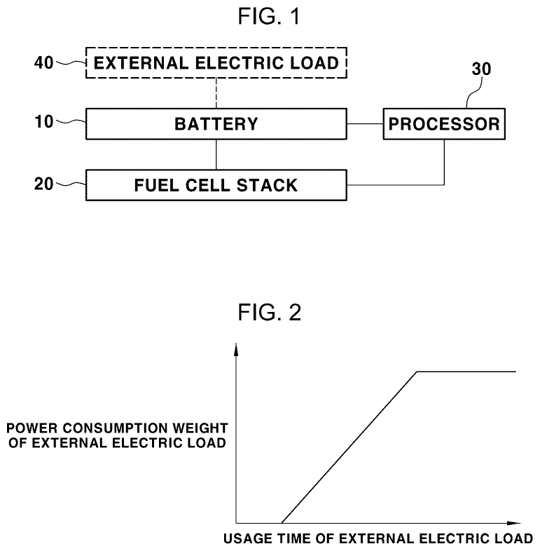

As illustrated in FIG. 1, a power supply system of a fuel cell vehicle according to an exemplary embodiment of the present disclosure includes a battery 10, a fuel cell stack 20, and a processor 30.

The battery 10 and the fuel cell stack 20 are disposed in the fuel cell vehicle. Although not shown in the drawing, the battery 10 is connected to an electric motor used as a power source of the fuel cell vehicle so that power may be supplied.

Furthermore, the battery 10 is optionally connected to an external electric load 40 of the vehicle. By connecting the battery 10 to the external electric load 40, a Vehicle to Load (V2L) function that utilizes electrical energy of the battery 10 outside the vehicle may be executed. The external electric load 40 is separately disposed outside the vehicle and may include, for example, a household electronic device.

The fuel cell vehicle (referred to hereinafter as “vehicle”) may include hardware for electrical connection between the battery 10 and the external electric load 40. For example, the vehicle may be disposed with an external discharge port for connection to the external electric load 40, and the external discharge port may be disposed with an electrical connection terminal that may be connected to the external electric load 40. Furthermore, the external discharge port may be connected to the battery 10 inside the vehicle through a V2L converter.

Furthermore, although not shown in the drawing, the vehicle may be disposed with an external discharge port door for opening and closing the external discharge port. The vehicle may be disposed with a door detection means for detecting opening and closing of the external discharge port door. The door detection means may transmit an electrical signal according to an opening and closing operation of the external discharge port door to the processor 30.

The fuel cell stack 20 is electrically connected to the battery 10 in the vehicle. The fuel cell stack 20 may be configured to generate electrical energy through an electrochemical reaction using a fuel and an oxidizer. When the fuel cell stack 20 is driven, electrical energy output from the fuel cell stack 20 may be supplied to the battery 10 to charge the battery 10. The vehicle may be disposed with hardware for converting electrical energy output from the fuel cell stack 20 into a form with which the battery 10 may be charged.

The processor 30 may include at least one controller disposed in the vehicle. For example, the processor 30 may include a battery controller for controlling discharge and charge of the battery 10 and a fuel cell controller for controlling driving of the fuel cell stack 20.

The processor 30 may be configured to determine whether the V2L function is used based on whether the external discharge port door is open or closed. The processor 30 may be configured to determine that the V2L function is used when the external discharge port door is open. That is, the processor 30 may be configured to determine that the battery 10 is connected to the external electric load 40 when the external discharge port door is open. The V2L function may be used when the vehicle is stopped. When the vehicle is stopped, the battery 10 does not supply power to a power source (i.e., electric motor) of the vehicle. When determining that the external discharge port door is closed, the processor 30 may be configured to determine that the external electric load 40 is not connected to the battery 10.

When determining that the external discharge port door is open, the processor 30 is configured to determine power consumption (i.e., external power consumption) of the external electric load 40 based on a discharge current and a discharge voltage output by the battery 10 in real time. The external power consumption is power required to drive the external electric load 40. In other words, the external power consumption is power drawn from the battery 10 and consumed by the external electric load 40.

When the vehicle power supply system enters the power-on mode, the processor 30 is configured to determine a V2L usage time based on a time for which the external discharge port door is open. In other words, the processor 30 recognizes the time for which the external discharge port door is open as a usage time of the external electric load 40 (i.e., the V2L usage time). The usage time of the external electric load 40 is a time for which the external electric load 40 is connected to the battery 10 and utilizes electrical energy of the battery 10. The power-on mode is a mode in which only the battery 10 among the battery 10 and the fuel cell stack 20, which are power supply sources of the vehicle, is used.

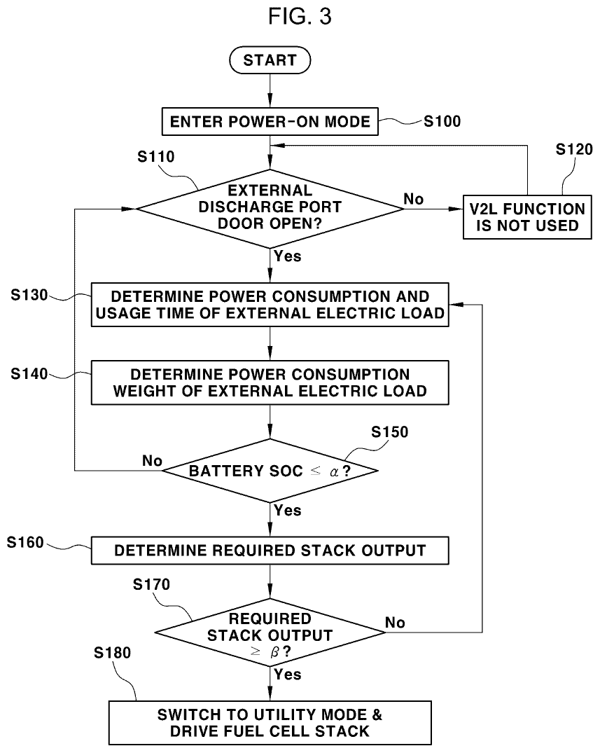

The processor 30 may be configured to determine an external power consumption weight based on the usage time of the external electric load 40. The external power consumption weight is a weight assigned to external power consumption. Referring to FIG. 2, the external power consumption weight may vary depending on the usage time of the external electric load 40. For example, the external power consumption weight may increase in proportion to the usage time of the external electric load 40. Furthermore, the external power consumption weight may be maintained at a certain value when the usage time of the external electric load 40 exceeds a critical time point.

The processor 30 may be configured to determine the external power consumption weight according to the usage time of the external electric load 40 in advance and store the external power consumption weight in memory. The memory may be disposed in the processor 30 or disposed separately from the processor 30. The processor 30 may use information stored in the memory as needed.

The processor 30 may be configured to determine required output (i.e., required stack output) of the fuel cell stack 20 based on the external power consumption and the external power consumption weight. The required stack output is power required by the external electric load 40 connected to the battery 10 from the fuel cell stack 20. When determining the required stack output, it is possible to ensure a margin for current external power consumption using the external power consumption weight. For example, the external power consumption weight may be determined to be a value greater than 1.

The processor 30 may be configured to determine that it is necessary to switch the driving mode of the power supply system to the utility mode when the SoC value of the battery 10 connected to the external electric load 40 reaches a predetermined lower limit α. In the present instance, to prevent the fuel cell stack 20 from being driven in a low output section, the processor 30 may be configured to determine whether the required stack output is greater than or equal to a predetermined lower limit output β. The predetermined lower limit output β is not a lower limit output that may be output by the fuel cell stack 20, but a lower limit output for preventing performance degradation and deterioration of the fuel cell stack 20. The predetermined lower limit α is determined by an SoC value that requires charging of the battery 10. For example, the predetermined lower limit α may be 40%, and the predetermined lower limit output β may be 15 kW. The predetermined lower limit α and the predetermined lower limit output β may be determined to different values depending on the specifications and conditions of the battery 10 and the fuel cell stack 20.

The SoC value of the battery 10 is determined based on an output voltage and an output current of the battery 10, a real-time temperature, a load, etc., and since a method of determining the SoC value of the battery 10 is well known, a detailed description thereof will be omitted.

The utility mode is a mode that uses both the battery 10 and the fuel cell stack 20 as power sources for the vehicle. When the driving mode of the power supply system is switched from the power-on mode to the utility mode, the fuel cell stack 20 is driven. In the utility mode, the vehicle is not driven.

In other words, the processor 30 may drive the fuel cell stack 20 when the SoC value of the battery 10 is less than or equal to the predetermined lower limit α in the power-on mode of the power supply system. In the present instance, to prevent the fuel cell stack 20 from being driven in an output section lower than the predetermined lower limit output β, a condition that the required stack output is higher than the predetermined lower limit output β may be included in conditions for determining whether to drive the fuel cell stack 20.

That is, the processor 30 drives the fuel cell stack 20 when the SoC value of the battery 10 is greater than or equal to the predetermined lower limit α and the required stack output is greater than or equal to the predetermined lower limit output β.

The required stack output may be determined based on the external power consumption and the external power consumption weighting as shown in Equation 1 below.

Required stack output=External power consumption×External power consumption weight Equation 1

When there is an additional electric load other than the external electric load 40, for example, when an electric load (i.e., an internal electric load) disposed inside the vehicle is used in addition to the external electric load 40, the required stack output may be added to the power consumption of the internal electric load. The internal electric load may include a radiator and an air conditioner disposed in the vehicle.

After the driving mode of the power supply system is switched to the utility mode, the processor 30 variably controls the output of the fuel cell stack 20 to maintain the SoC value of the battery 10 higher than the SoC value during normal driving. By maintaining the SoC value of the battery 10 higher than the SoC during normal driving, frequent driving and stop of the fuel cell stack 20 may be prevented.

The processor 30 may perform output control of the fuel cell stack 20 for SoC regulation using a map configured to determine the required battery output according to the real-time SoC value. The SoC value of the battery 10 may vary depending on the power consumption of the external electric load 40 and the power supply of the fuel cell stack 20. The processor 30 may be configured to determine the required battery output based on the real-time SoC value of the battery 10 through the map, and may be configured to determine the output of the fuel cell stack 20 based on the determined required battery output.

The required battery output is the output required for the fuel cell stack 20 according to the real-time SoC value, and is the output required for charging the battery 10 according to the real-time SoC value. In other words, the required battery output is the output required for the fuel cell stack 20 in real time for charging the battery 10.

By controlling the output of the fuel cell stack 20 based on the real-time SoC value of the battery 10, the fuel cell stack 20 may be prevented from being driven for a long time period in an output section lower than the predetermined lower limit output β for preventing deterioration, and thus performance degradation of the fuel cell stack 20 caused by use in the low output section may be prevented.

The processor 30 may stop driving of the fuel cell stack 20 when the SoC value of the battery 10 reaches a predetermined SoC value γ. The SoC value γ is set to a value that may stop charging of the battery 10. For example, the SoC value γ may be 80%. The SoC value γ may be set to a different value depending on the specifications and state of the battery 10.

As described above, by controlling the output of the fuel cell stack 20 based on the real-time SoC value of the battery 10, the SoC value of the battery 10 may be maintained at a higher state than the SoC during normal driving. By maintaining the SoC value of the battery 10 at a higher state than the SoC value during normal driving, frequent driving and stop of the fuel cell stack 20 may be prevented.

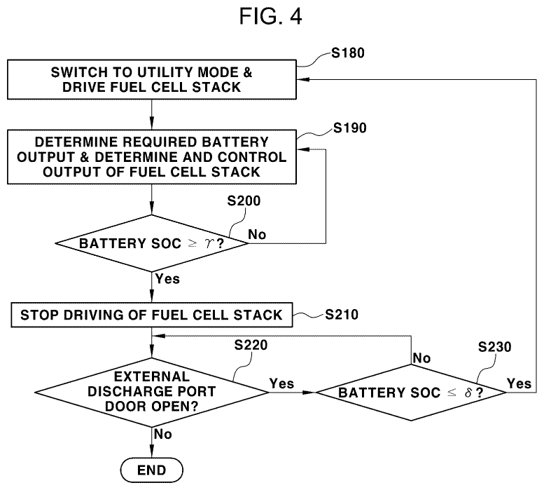

Meanwhile, a control process for continuous power supply of the power supply system according to an exemplary embodiment of the present disclosure will be described with reference to FIG. 3 and FIG. 4.

As shown in FIG. 3, the processor 30 is configured to determine whether the external discharge port door is open (S110) when the vehicle power supply system enters the power-on mode (S100). The processor 30 may be configured to determine whether the external discharge port door is open based on a transmission signal of the door detection means.

When the external discharge port door is closed, the processor 30 is configured to determine that the V2L function is not used (S120). For example, when the external discharge port door is closed, the processor 30 may determine that the external electric load 40 is not connected to the external discharge port of the vehicle.

When the external discharge port door is open, the processor 30 is configured to determine each of the power consumption and usage time of the external electric load 40 to use the V2L function (S130). The processor 30 may count the usage time of the external electric load 40 from a time when a door open signal is received from the door detection means.

Next, the processor 30 is configured to determine a weight for the power consumption of the external electric load 40 based on the usage time of the external electric load 40 S140.

The processor 30 compares the SoC value of the battery 10 with the predetermined lower limit α S150. When the SoC value of the battery 10 is less than or equal to the predetermined lower limit α, the processor 30 is configured to determine the required output (i.e., the required stack output) for the fuel cell stack 20 (S160). The required stack output is determined based on the power consumption and the power consumption weight of the external electric load 40.

When the SoC value of the battery 10 exceeds the predetermined lower limit α, the processor 30 does not drive the fuel cell stack 20 and determines again whether the external discharge port door is open (S110). When the SoC value of the battery 10 exceeds the predetermined lower limit output β and the external discharge port door is open, the processor 30 monitors the SoC value of the battery 10 in real time.

When the SoC value of the battery 10 is less than or equal to the predetermined lower limit α, the processor 30 compares the required stack output with the predetermined lower limit output β (S170). When the required stack output is greater than or equal to the predetermined lower limit output β, the processor 30 switches the driving mode of the power supply system from the power-on mode to the utility mode (S180). When the required stack output is less than the predetermined lower limit output β, the processor 30 does not drive the fuel cell stack 20, redetermines the power consumption and usage time of the external electric load 40 (S130), and redetermines the external power consumption weight based on the usage time of the external electric load 40 (S140).

The driving mode of the power supply system may be manually switched using a user input module disposed in the vehicle interior, when necessary.

As shown in FIG. 4, when the driving mode of the power supply system is switched to the utility mode and the fuel cell stack 20 is driven (S180), the processor 30 is configured to determine the required battery output based on the real-time SoC value of the battery 10, and is configured to determine and control the output of the fuel cell stack 20 based on the determined required battery output (S190). In the present instance, the battery 10 is charged with the power supplied to the battery 10 by the fuel cell stack 20, and the SoC value of the battery 10 increases.

While controlling the output of the fuel cell stack 20, the processor 30 compares the SoC value of the battery 10 with a first SoC value γ determined in advance (S200). When the SoC value of the battery 10 is less than the first SoC value γ, the processor 30 redetermines the required battery output, and redetermines and controls the output of the fuel cell stack 20 based on the redetermined required battery output (S190).

When the SoC value of the battery 10 is greater than or equal to the first SoC value γ, the processor 30 stops driving of the fuel cell stack 20 (S210) and redetermines whether the external discharge port door is open (S220).

When the external discharge port door is closed, the processor 30 is configured to determine that the external electric load 40 is separated from the battery 10 and may terminate charging of the battery 10.

When driving of the fuel cell stack 20 is stopped and the external discharge port door remains open, the processor 30 compares the SoC value of the battery 10 with a predetermined second SoC value δ (S230). When the SoC value of the battery 10 exceeds the second SoC value δ, the processor 30 is configured to determine again whether the external discharge port door is open (S220). When the SoC value of the battery 10 is less than or equal to the second SoC value δ, the processor 30 is configured to determine that the SoC value of the battery 10 decreases after driving of the fuel cell stack 20 is stopped and redrives the fuel cell stack 20 (S180).

In other words, when driving of the fuel cell stack 20 is stopped, a connection state between the external electric load 40 and the battery 10 is maintained, and the SoC value of the battery 10 is less than or equal to the second SoC value δ, the processor 30 redrives the fuel cell stack 20 (S180). The processor 30 redrives the fuel cell stack 20 to charge the battery 10 so that the SoC value of the battery 10 is maintained at a certain level. According to an exemplary embodiment of the present disclosure, the second SoC value δ may be set to a value less than the first SoC value γ.

According to the means for solving the above-described problem, the present disclosure provides the following effects.

First, while the power of the battery disposed in the vehicle is being used outside the vehicle, the driving mode of the power supply system is automatically switched to the utility mode for driving the fuel cell stack. Accordingly, the user may continuously use the power of the battery outside the vehicle without manually switching the driving mode of the power supply system.

Second, convenience is increased since the V2L function may be continuously used without interruption without user operation.

Third, by determining the required output of the fuel cell stack based on the power consumption and usage time of the external electric load, and switching the driving mode of the power supply system to the utility mode only when the required output is greater than or equal to the set lower limit output, continuous driving is prevented in a low output section that may cause performance degradation and deterioration of the fuel cell stack.

The effects of the present disclosure are not limited to the effects described above, and other effects of the present disclosure not mentioned herein will be clearly understood by those skilled in the art to which the present disclosure pertains from the above description.

The exemplary embodiments of the present disclosure have been described in detail above, and the terms used in the present specification and claims should not be interpreted as being limited to conventional or dictionary meanings. Furthermore, the scope of the rights of the present disclosure is not limited to the exemplary embodiments described above, and encompasses various modifications and improvements made by those skilled in the art using the basic concept of the present disclosure defined in the claims below.

What is claimed is:

1. A power supply system of a fuel cell vehicle, the power supply system comprising:
a battery disposed in the vehicle;
a fuel cell stack generating electrical energy allowed to be supplied to the battery; and
a processor determining whether to drive the fuel cell stack based on a state of charge (SoC) value of the battery and a required output of the fuel cell stack based on an external electric load being connected to the battery, and controlling driving of the fuel cell stack based on the determining.

2. The power supply system of claim 1, wherein the processor drives the fuel cell stack based on the SoC value of the battery being less than or equal to a predetermined lower limit, and the required output of the fuel cell stack being greater than or equal to a predetermined lower limit output.

3. The power supply system of claim 2, wherein the processor does not drive the fuel cell stack based on the SoC value of the battery exceeding the predetermined lower limit.

4. The power supply system of claim 2, wherein the processor does not drive the fuel cell stack based on the required output of the fuel cell stack being less than the predetermined lower limit output.

5. The power supply system of claim 2, wherein the processor redetermines the required output of the fuel cell stack based on the required output of the fuel cell stack being less than the predetermined lower limit output.

6. The power supply system of claim 1,
wherein the required output of the fuel cell stack is determined by the processor based on power consumption of the external electric load and a weight for the power consumption, and
wherein the weight is determined by the processor based on a usage time of the external electric load.

7. The power supply system of claim 1, wherein the processor determines and controls output of the fuel cell stack based on the SoC value of the battery based on the fuel cell stack being driven.

8. The power supply system of claim 1, wherein the processor stops driving of the fuel cell stack based on determining of the fuel cell stack being driven and the SoC value of the battery being greater than or equal to a predetermined first SoC value.

9. The power supply system of claim 8, wherein the processor redrives the fuel cell stack based on driving of the fuel cell stack being stopped, a connection of the external electric load and the battery being maintained, and the SoC value of the battery being less than or equal to a predetermined second SoC value.

10. The power supply system of claim 1, wherein the processor switches the power supply system to a utility mode in which the fuel cell stack is driven based on the SoC value of the battery being less than or equal to a predetermined lower limit, and the required output of the fuel cell stack is greater than or equal to a predetermined lower limit output.

11. A fuel cell vehicle comprising the power supply system of claim 1.

12. A power supply method of a fuel cell vehicle, the power supply method comprising:
determining, by a processor, whether to interconnect a battery disposed in the vehicle and an external electric load of the vehicle;
determining, by the processor, a required output of a fuel cell stack disposed in the vehicle and generating electrical energy allowed to be supplied to the battery; and
driving, by the processor, the fuel cell stack based on the external electric load being connected to the battery, a state of charge (SoC) value of the battery being less than or equal to a predetermined lower limit, and the required output of the fuel cell stack being greater than or equal to a predetermined lower limit output.

13. The power supply method of claim 12, further comprising not driving, by the processor, the fuel cell stack based on the SoC value of the battery exceeding the predetermined lower limit.

14. The power supply method of claim 12, further comprising not driving, by the processor, the fuel cell stack based on the required output of the fuel cell stack being less than the predetermined lower limit output.

15. The power supply method of claim 12, further comprising redetermining, by the processor, the required output of the fuel cell stack based on the required output of the fuel cell stack being less than the predetermined lower limit output.

16. The power supply method of claim 12,
wherein the required output of the fuel cell stack is determined by the processor based on power consumption of the external electric load and a weight for the power consumption, and
wherein the weight is determined by the processor based on a usage time of the external electric load.

17. The power supply method of claim 12, further comprising determining and controlling output of the fuel cell stack based on the SoC value of the battery based on the fuel cell stack being driven.

18. The power supply method of claim 12, further comprising stopping, by the processor, driving of the fuel cell stack based on determining of the fuel cell stack being driven and the SoC value of the battery being greater than or equal to a predetermined first SoC value.

19. The power supply method of claim 18, further comprising redriving, by the processor, the fuel cell stack based on driving of the fuel cell stack being stopped, a connection of the external electric load and the battery being maintained, and the SoC value of the battery being less than or equal to a predetermined second SoC value.

20. A non-transitory computer readable storage medium on which a program for performing the method of claim 12 is recorded.
